(19) United States
(12) Patent Application Publication
(10) Pub. No.: US 2012/0084356 A1
(43) Pub. Date: Apr. 5, 2012

(54) METHOD AND APPARATUS FOR MEDIA SESSION SHARING AND GROUP SYNCHRONIZATION OF MULTI MEDIA STREAMS

(75) Inventor: Samir Ferdi, Kirkland (CA)

(73) Assignee: INTERDIGITAL PATENT HOLDINGS, INC., Wilmington, DE (US)

(21) Appl. No.: 12/985,255

(22) Filed: Jan. 5, 2011

Related U.S. Application Data
(60) Provisional application No. 61/389,156, filed on Oct. 1, 2010.

(51) Int. Cl. G06F 15/16

(52) U.S. Cl. 709/204

(57) ABSTRACT

A method and apparatus for synchronizing, transforming, modifying, duplicating and retrieving media streams between wireless transmit/receive units (WTRUs) that may not be IMS-capable in real-time, via Inter-User Equipment Transfer (IUT) across any internet protocol (IP) based network. This framework allows for both collaborative and non-collaborative media sessions, media session transport and shared media session control under the same subscription or multiple subscriptions.

### CROSS REFERENCE TO RELATED APPLICATIONS

This application claims the benefit of U.S. Provisional Application Ser. No. 61/389,156 filed on Oct. 1, 2010, the contents of which are hereby incorporated by reference herein.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as Universal Mobile Telecommunication System (UMTS) Terrestrial Radio Access Network (UTRAN), Long Term Evolution (LTE), Worldwide Interoperability for Microwave Access (WiMax), or Wireless Local Area Network (WLAN) technology. Some procedures available through the use of IMS are the transfer, modification, replication and retrieval of media sessions between IMS-capable WTRUs in real-time. These procedures are known as Inter-User Equipment Transfer (IUT). However, IMS IUT is tightly bound to the IMS infrastructure and requires IMS-capable WTRUs. Accordingly, it would be advantageous for a media mobility framework that allows media streams to be synchronized, transferred, modified, duplicated and retrieved between WTRUs that may not be IMS-capable in real-time via IUT across any internet protocol (IP) based network.

### SUMMARY

A method and apparatus for synchronizing, transforming, modifying, duplicating and retrieving media streams between WTRUs that may not be IMS-capable in real-time via Inter-User Equipment Transfer (IUT) across any internet protocol (IP) based network. This framework allows for both collaborative and non-collaborative media sessions, media session transport and shared media session control under the same subscription or multiple subscriptions.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of an example of a media mobility framework wherein media flows may be transferred, modified, duplicated or retrieved between IP media clients across any IP based network;

FIG. 3A shows a system diagram of an example of a media session transfer;

FIG. 3B shows a flow diagram of an example of a media session transfer;

FIG. 4A shows system diagram of an example of media session sharing;

FIG. 4B shows a flow diagram of an example of a media session sharing;

FIG. 5A shows system diagram of an example of media session retrieval procedure;

FIG. 5B shows a flow diagram of an example of a media session retrieval procedure;

FIG. 6A1 shows a system diagram of an example of media session pause and resume procedure;

FIG. 6A2 is a continuation of 6A1;

FIG. 6B shows a flow diagram of an example of a media session pause and resume procedure;

FIG. 7 shows a system diagram of an example of peer media user discovery and interaction;

FIG. 8A shows a system diagram of an example of peer device detection and monitoring;

FIG. 8B shows a flow diagram of an example of peer client detection and monitoring;

FIG. 9A shows system diagram of an example of shared trick-play session setup;

FIG. 9B shows a flow diagram of an example of shared trick-play session setup;

FIG. 10 shows a flow diagram of an example of trick-play command flow;

FIG. 11 shows a flow diagram of an example of trick-play control transfer using a push model;

FIG. 12 shows a flow diagram of an example of a shared trick-play session leaving procedure;

FIG. 13 shows a flow diagram of an example of a shared trick-play session termination procedure; and

FIG. 14 shows a flow diagram of an example of group media stream synchronization.

### DETAILED DESCRIPTION

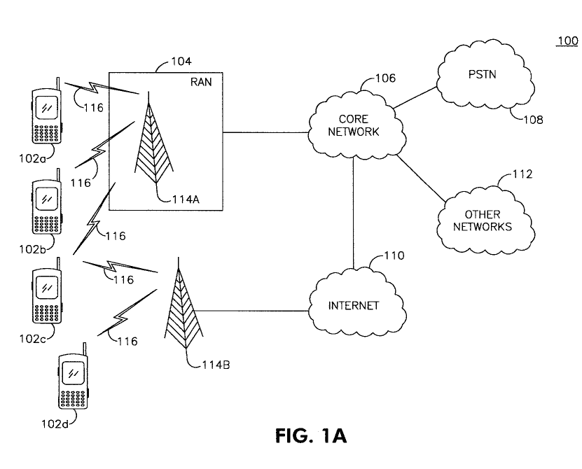

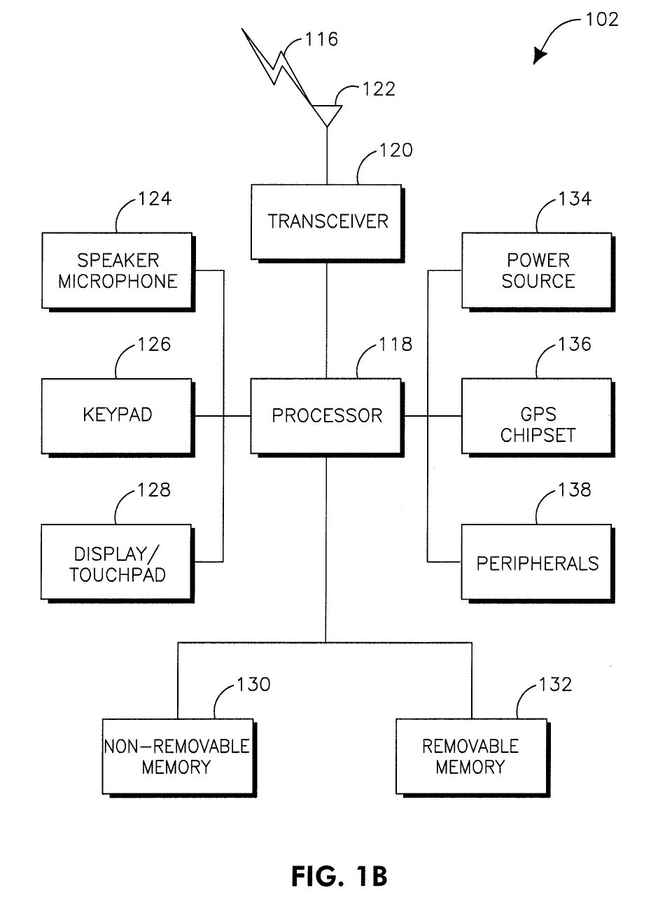

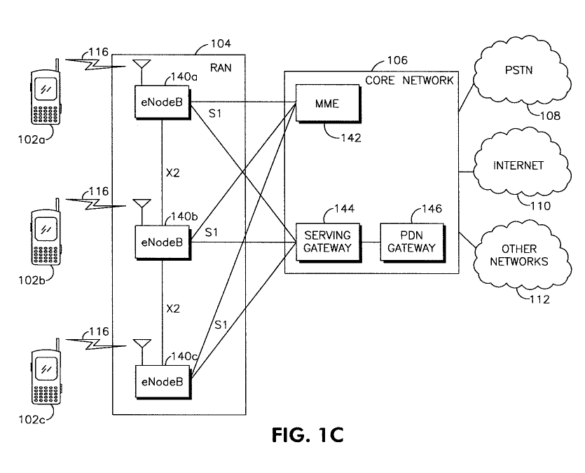

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

A generic internet protocol (IP) based media mobility framework using a control protocol for media stream transferring, synchronizing, modifying, replicating and retrieving is described herein. A controlling device may remotely control media streams for at least one controlled device by issuing commands using a control protocol such as a central media streaming server. A media streaming server augmented with trick-play or trick-mode command flow management may support several controlling devices simultaneously. Shared control of media play-back (i.e., play, pause, seek), is known as trick-play or trick-mode. A need exists for group synchronization and remote control of streams including but not limited to Hyper Text Transport protocol (HTTP) and Real Time Streaming Protocol (RTSP) that are delivered from multiple media sources.

While an extensible messaging and presence protocol (XMPP) may be described in the embodiments, any control protocol may be used. XMPP is an open, extensible markup language (XML) based protocol aimed at real-time extensible instant messaging (IM) and provides presence information. Built to be extensible, XMPP has been extended with features such as voice over IP (VOIP) and file transfer signaling.

A general trend towards real-time social media, whereby end users are able to share and consume the same media content in real-time while interacting, drives a need for synchronization of media streams across several devices. In addition, shared control of media play back, remote control of media devices and synchronization of shared media streams among several receiving devices is also needed.

The herein framework allows for collaborative sessions where the media stream is transferred or replicated while remaining under the control of one device and for non-collaborative sessions where both the media stream and its control are transferred between devices. The herein framework also allows for standard media stream transport and may include but is not limited to HTTP or RTSP. In addition, the herein framework also allows for sessions to be controlled between devices under the same subscription (i.e., a single user) or different subscriptions (i.e., multiple users). These mechanisms may be embodied in any IP network and in particular over the Web as a way to address an increasing need for mobile and collaborative real-time media stream mass consumption.

Group synchronization of multiple media streams across several devices as well as shared control of media play-back (i.e., play, pause, seek), also known as trick-play or trick-mode, is described herein. A device may be configured as a trick-play controller and may also be a media synchronization source. The control may be transferred from a controller to a controlee, any device controlled by the controller. This transfer may occur based on a push or a pull mechanism or by user actions. In addition, trick-play synchronization messages may be sent by a controlling device to controlled devices via a control protocol (i.e., an XMPP server). While media synchronization messages may be triggered automatically on a periodic basis, trick-play messages are triggered by user input (i.e., play, pause, seek). Controlled devices adjust their state in response to the trick-play message.

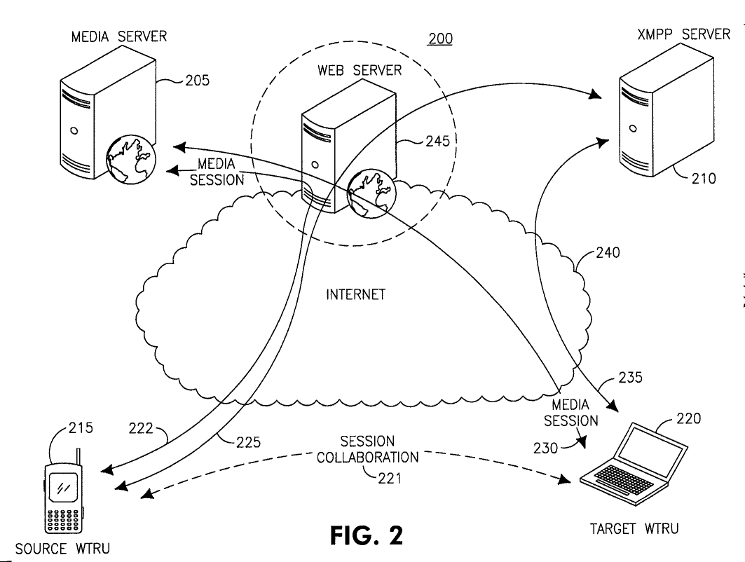

FIG. 2 shows a diagram of a media mobility framework 200 wherein media flows may be transferred, modified, duplicated or retrieved between IP media clients (e.g., WTRUs) across any IP based network. The media streams may be between a single WTRU or multiple WTRUs via IUT wherein XMPP may be used as a control protocol and may be transported over transmission control protocol (TCP). While XMPP is described in this embodiment any control protocol may be used.

An IP based media mobility framework using a control protocol such as XMPP may allow for collaborative sessions where a media stream is transferred or replicated while remaining under the control of one device or for non-collaborative sessions where both the media stream and control of the media stream are transferred between devices. Any standard media protocol may be used with the media flows including but not limited to HTTP or RSTP. In addition, any IP network 240 as well as the Web may be used with the media flows.

Through the use of an XMPP server 210 in the network and XMPP clients in each WTRU, media stream mobility and collaboration may be enabled. An XMPP server 210 in the network interacts with XMPP clients in each WTRU, to provide several functions 225, 235 including but not limited to: 1) session mobility and collaboration control; 2) session bookmarking; 3) peer media client detection and monitoring; and 4) peer media user discovery and interaction. XMPP clients may be located in each WTRU and provide similar functions to the XMPP server 210.

Media may be streamed over any standard protocol using a media server 205. The media server 205 may establish a session 222 with a source WTRU 215 and a session 230 with a target WTRU 220. The source WTRU 215 and the target WTRU 220 may also establish a collaborative session with each other 221.

At any point in the method of FIG. 2, additional actions may be performed between the XMPP server 210, the media server 205, the source WTRU 215 and the target WTRU 220.

In an alternate embodiment of FIG. 2, a web based architecture is proposed where the XMPP server 210 uses a web server 245 as a proxy and XMPP may be transmitted over HTTP. In this embodiment, each XMPP client runs within the web browser on each WTRU. Both the source WTRU 215 and the target WTRU 220 communicate with the media server 205 and XMPP server 210 via the web server. While XMPP is described in this embodiment any control protocol may be used.

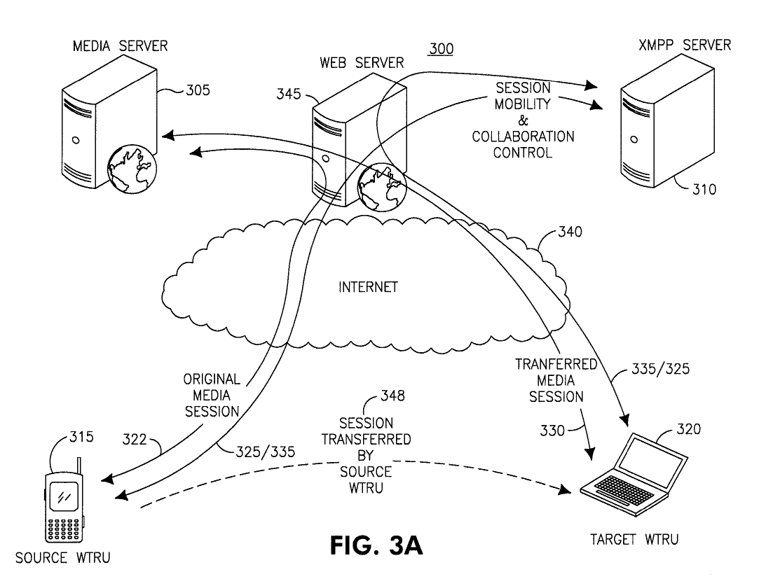

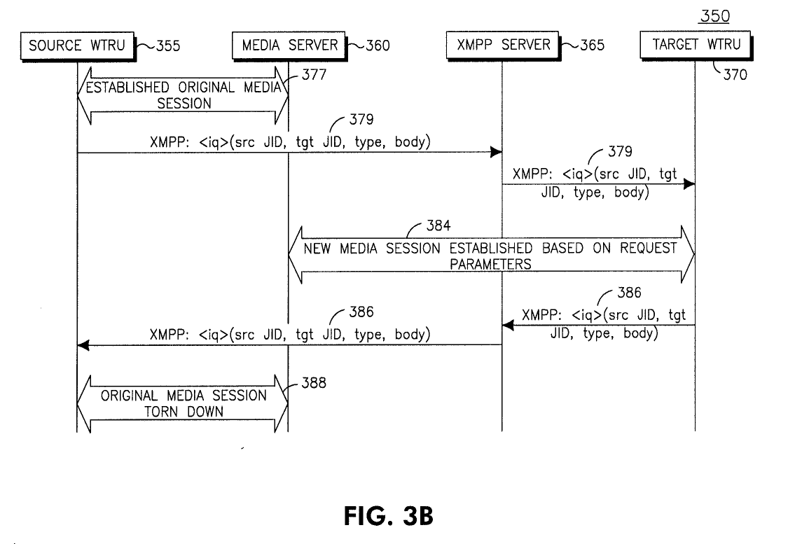

FIG. 3A shows a system diagram 300 of an example of a media session transfer from a source WTRU 315 to a target WTRU 320 via an XMPP server 310 using a web server 345 as a proxy. Any standard media protocol may be used with the media flows including but not limited to HTTP or RSTP. In addition, any IP network 340 as well as the Web may be used with the media flows.

The source WTRU 315 establishes an original media session 322 with the media server 305 via the web server 345. The source WTRU 315 sends a session transfer request 325 to the XMPP server 310 via the web server 345. The XMPP server 310 receives the request 325 and forwards the request 325 to the target WTRU 320 via the web server 345. The session is transferred 348 to the target WTRU 320 and the session 330 is established between the target WTRU 320 and the media server 305 via the web server 345 according to the parameters received in the session transfer request 325. A session transfer response 335 is sent to the XMPP server 310 by the target WTRU 320 via the web server 345. The session transfer response 335 is sent to the source WTRU 315 by the XMPP server 310 via the web server 345. The source WTRU 315 terminates the original media session.

At any point in the method of FIG. 3A, additional actions may be performed between the XMPP server 310, the web server 345, the media server 305, the source WTRU 315 and the target WTRU 320. While XMPP is described in this embodiment any control protocol may be used.

FIG. 3B shows a flow diagram 350 of an example of a media session transfer from a source WTRU 355 to a target WTRU 370 via an XMPP server 365 using an XML transfer request. The source WTRU 355 establishes an original session 377 with the media server 360. The source WTRU 355 sends a session transfer request 379 using an XML Info/Query (IQ, <iq>) stanza. The <iq> stanza is a request-response mechanism. The semantics of <iq> stanza enable an entity to make a request of, and receive a response from, another entity (i.e., transfer request). In this embodiment, a <iq> transfer request 379 is sent by the source WTRU 355 to the XMPP server 365 that includes a header with a from field specifying a source device identification (src JID), a to field specifying a target device identification (tgt JID), a type field which may contain a transaction id and a body, which may include media stream information elements including but is not limited to URL and time offset and a command type specifying a transfer. The XMPP server 365 receives the request 379 and forwards the request 379 to the target WTRU 370. Upon receipt of the session transfer request 379, the target WTRU 370 establishes a session 384 with the media server 360 based on the parameters received in the session transfer request 379.

An <iq> session transfer response 386 is sent to the XMPP server 365 by the target WTRU 370. The <iq> session transfer response 386 includes a source device identification (src JID), a target device identification (tgt JID), a type and a body. The session transfer response 386 is sent to the source WTRU 355 by the XMPP server 365. The receipt of the session transfer response 386 by the source WTRU 355 denotes the end of the transfer of the media session. The source WTRU 355 terminates the original media session 388.

At any point in the method of FIG. 3B, additional actions may be performed between the XMPP server 365, the media server 360, the source WTRU 355 and the target WTRU 370. While XMPP is described in this embodiment any control protocol may be used.

In a first alternative embodiment to FIG. 3B a media session transfer between a source WTRU 355 and a target WTRU 370 via an XMPP sever 365 using an XML message stanza occurs.

A source WTRU 355 issues a session transfer request 379 to the XMPP server 365 using a XML message (<message>) stanza to request a media session transfer. The <message> stanza is a type of “push” mechanism whereby one entity pushes information to another entity, similar to the communications that occur in a system such as email. The <message> stanzas may possess a ‘to’ attribute that specifies the intended recipient of the message; upon receiving such a stanza, a server may route or deliver it to the intended recipient. The session transfer request message includes a source device identification (src JID), a target device identification (tgt JID), a transaction id, a type and a body which may include media stream information elements including but is not limited to URL and time offset. The XMPP server 365 receives the session transfer request message 379 and forwards the message 379 to the target WTRU 370. Upon receipt of the message 379, the target WTRU 370 establishes a session 384 with the media server 360 based on the parameters received in the session transfer request message 379. The target WTRU 370 may send a response <message> to the XMPP server 365, which is forwarded to the source WTRU 355. The receipt of the <message> response signifies the end of the transfer of the media session and the source WTRU 355 terminates the media session 388 with the media server 360.

A presence primitive may be broadcast to the XMPP server 365 by the target WTRU 370 to convey the establishment of a media stream based on the parameters received in the session transfer request message 379. The receipt of the presence primitive by the source WTRU 355 may denote the end of the transfer of the media session. The source WTRU 355 may terminate the original media session.

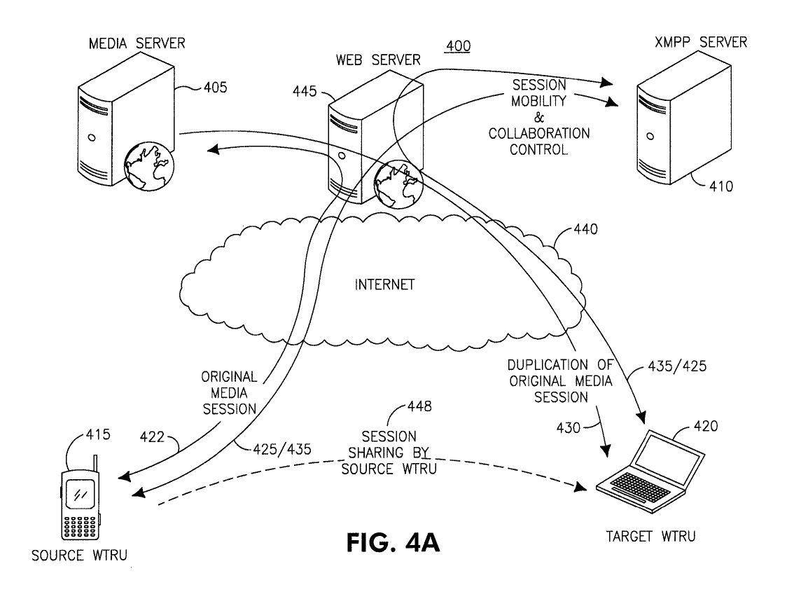

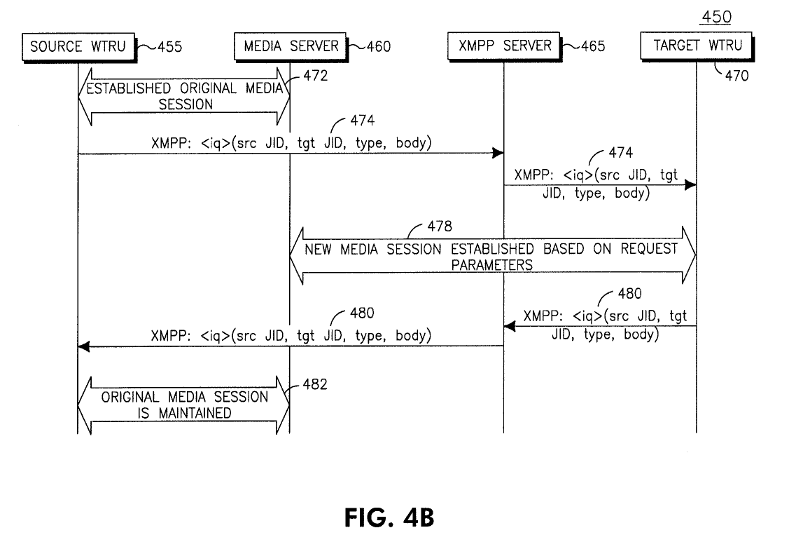

FIG. 4A shows system diagram of an example of media session sharing 400 between a source WTRU 415 and a target WTRU 420 via an XMPP server 410 using a web server 445 as a proxy. Any standard media protocol may be used with the media flows including but not limited to HTTP or RSTP. In addition, any IP network 440 as well as the Web may be used with the media flows.

The source WTRU 415 establishes an original media session 422 with the media server 405 via the web server 445. The source WTRU 415 sends a session sharing request 425 to the XMPP server 410 via the web server 445. The XMPP server 410 receives the request 425 and forwards the request 425 to the target WTRU 420 via the web server 445. A session is established 430 between the target WTRU 420 and the media server 405 via the web server 445 according to the parameters received in the session sharing request 425. A session sharing response 435 is sent to the XMPP server 410 by the target WTRU 420 via the web server 445. The session sharing response 435 is sent to the source WTRU 415 by the XMPP server 410 via the web server 445. The source WTRU 415 maintains the original media session in collaboration 448 with the target WTRU 420.

At any point in the method of FIG. 4A, additional actions may be performed between the XMPP server 410, the web server 445, the media server 405, the source WTRU 415 and the target WTRU 420. While XMPP is described in this embodiment any control protocol may be used.

FIG. 4B shows a flow diagram of an example of a media session 450 sharing between a source WTRU 455 and a target WTRU 470 via an XMPP server 465 using an XML sharing request.

The source WTRU 455 establishes an original session 472 with the media server 460. The source WTRU 455 sends a session sharing request 474 using an XML <iq> stanza to the XMPP server 465 that includes a header with a from field that specifies a source device identification (src JID), a target device identification (tgt JID), a type, which may include a transaction id and a body, which may include media stream information elements including but is not limited to URL and time offset and a command type set to sharing. The XMPP server 465 receives the request 474 and forwards the request 474 to the target WTRU 470. Upon receipt of the session sharing request 474, the target WTRU 470 establishes a session 478 with the media server 460 based on the parameters received in the session sharing request 474.

An <iq> session sharing response 480 is sent to the XMPP server 460 by the target WTRU 470. The session sharing response message 480 includes a header with a to field specifying a source device identification (src JID), from field specifying a target device identification (tgt JID), a type field which may include a result and an original id and a body which may include the result of the embodiment operation. The session sharing response 480 is sent to the source WTRU 455 by the XMPP server 465. The source WTRU 455 maintains the original media session 482.

At any point in the method of FIG. 4B, additional actions may be performed between the XMPP server 465, the media server 460, the source WTRU 455 and the target WTRU 470. While XMPP is described in this embodiment any control protocol may be used.

In an alternative embodiment to FIG. 4B media session sharing between a source WTRU and a target WTRU via an XMPP sever using XML may be achieved using a <message> or a <presence> stanza in the place of the <iq> stanza may occur. The <presence> element may be a basic broadcast or “publish-subscribe” mechanism, whereby multiple entities receive information about an entity to which they have subscribed. A publishing entity may send a presence stanza without a ‘to’ attribute, in which case the server to which the entity is connected may broadcast or multiplex that stanza to all subscribing entities. However, a publishing entity may also send a presence stanza with a ‘to’ attribute, in which case the server may route or deliver that stanza to the intended recipient.

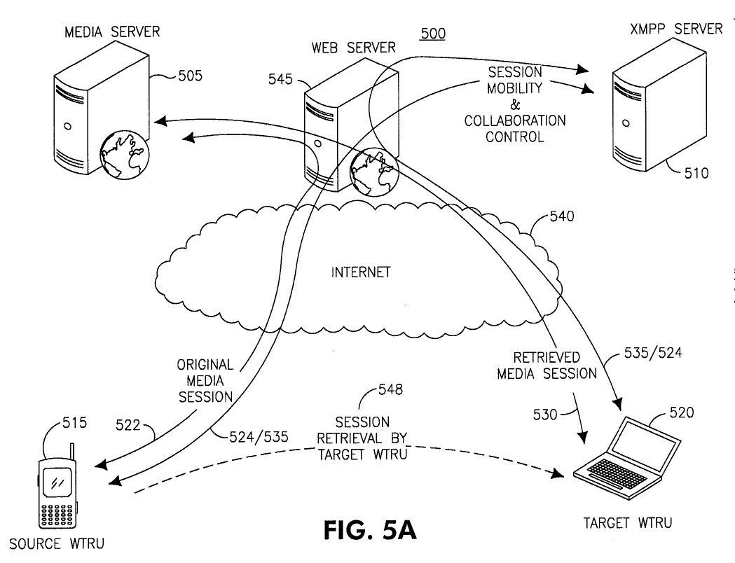

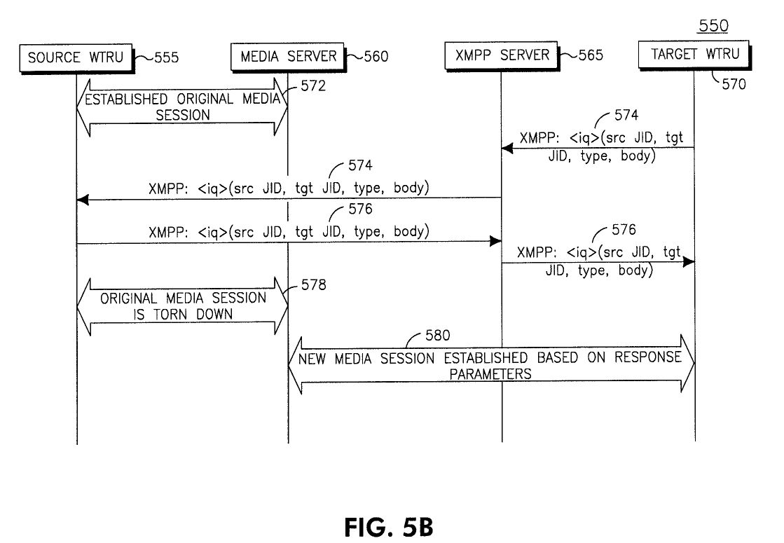

FIG. 5A shows system diagram of an example of media session retrieval 500 between a source WTRU 515 and a target WTRU 520 via an XMPP server 510 using a web server 545 as a proxy. Any standard media protocol may be used with the media flows including but not limited to HTTP or RSTP. In addition, any IP network 540 as well as the Web may be used with the media flows.

The source WTRU 515 establishes an original media session 522 with the media server 505 via the web server 545. The target WTRU 520 sends a session retrieval request 535 to the XMPP server 510 via the web server 545. The XMPP server 510 receives the request 535 and forwards the request 535 to the source WTRU 515 via the web server 545. A session retrieval response 524 is sent to the XMPP server 510 by the source WTRU 515 via the web server 545. The source WTRU 515 terminates the original media session 522. The session retrieval response 524 is sent to the target WTRU 520 by the XMPP server 510 via the web server 545. The session is retrieved 548 by the target WTRU 520 and the target WTRU 520 establishes a session 530 with the media server 505 based on the parameters received in the session retrieval response 524.

At any point in the method of FIG. 5A, additional actions may be performed between the XMPP server 510, the web server 545, the media server 505, the source WTRU 515 and the target WTRU 520. While XMPP is described in this embodiment any control protocol may be used.

FIG. 5B shows a flow diagram of an example of a media session retrieval 550 between a source WTRU 555 and a target WTRU 570 via an XMPP server 565 using an XML retrieval request.

The source WTRU 555 establishes an original session 572 with the media server 560. The target WTRU 570 transmits a XML <iq> session retrieval request 574 to the XMPP server 565 that includes a source device identification (src JID), a target device identification (tgt JID), a type, which may be a transaction id and a body, which may include media stream information elements including but is not limited to URL and time offset. The XMPP server 565 may receive the request 574 and may forward the request 574 to the source WTRU 555. Upon receipt of the session retrieval request 574, the source WTRU 555 may transmit a session retrieval response 576 to the XMPP server 565. The session retrieval response message 576 may include a source device identification (src JID), a target device identification (tgt JID), a type and a body. The session retrieval response 576 may be sent to the target WTRU 570 by the XMPP server 565. The source WTRU 555 terminates the original media session 578. A new media session 580 is established between the target WTRU 570 and the media server 560 based on the parameters received in the session retrieval response 576.

At any point in the method of FIG. 5B, additional actions may be performed between the XMPP server 565, the media server 560, the source WTRU 555 and the target WTRU 570. While XMPP is described in this embodiment any control protocol may be used.

In an alternative embodiment to FIG. 5B media session retrieval between a source WTRU and a target WTRU via an XMPP sever using an XML <message> stanza or a <presence> stanza instead of using a <iq> stanza may occur.

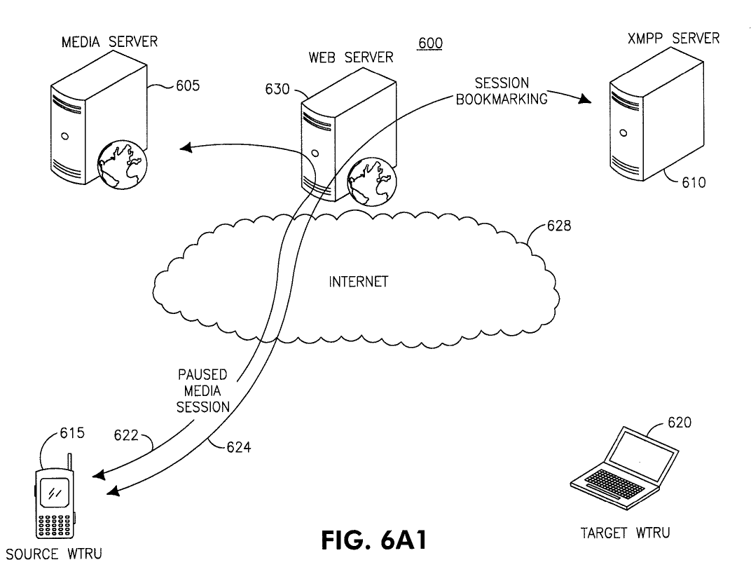

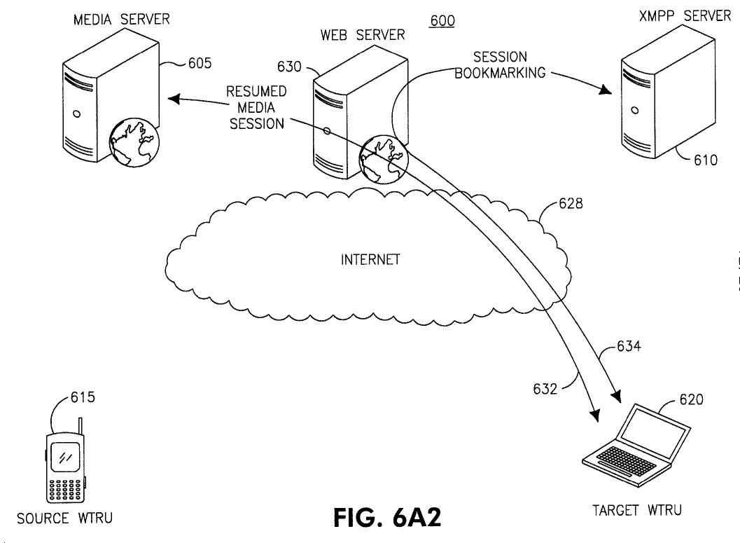

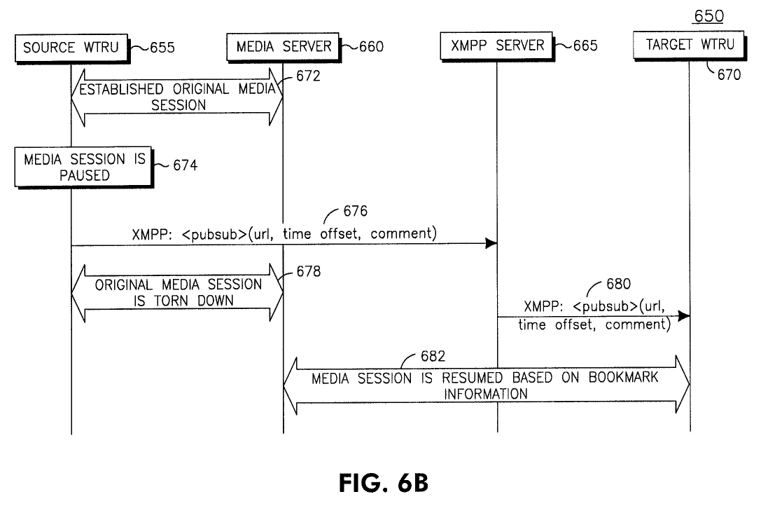

FIGS. 6A1 and 6A2 show system diagrams of an example of media session pause and resume 600 between a source WTRU 615 and a target WTRU 620 via an XMPP server 610 using a web server 630 as a proxy. Any standard media protocol may be used with the media flows including but not limited to HTTP or RSTP. In addition, any IP network 628 as well as the Web may be used with the media flows.

In FIG. 6A1 the source WTRU 615 establishes an original media session 622 with the media server 605 via the web server 630. The source WTRU 615 sends a session pause request 624 to the XMPP server 610 via the web server 630. The session is paused on the source WTRU 615 and the media server 605. The source WTRU 615 also sends a new bookmark 624 with the session information and the time offset of when the session paused to the XMPP server 610. The source WTRU 615 terminates the media session. In both FIGS. 6A1 and 6A2 the XMPP server 610 stores the bookmark information 624.

In FIG. 6A2 the target WTRU 620 retrieves the latest session bookmark information 634. The target WTRU 620 establishes a session 632 with the media server 605 according the parameters stored in the bookmark information 634.

At any point in the method of FIG. 6A1 or 6A2, additional actions may be performed between the XMPP server 610, the web server 630, the media server 605, the source WTRU 615 and the target WTRU 620. While XMPP is described in this embodiment any control protocol may be used.

FIG. 6B shows a flow diagram of an example of a media session pause and resume procedure 650 between a source WTRU 655 and a target WTRU 670 via an XMPP server 665 using an XMPP publish and subscribe <pubsub> protocol extension. Senders (publishers) of messages do not program the messages to be sent directly to specific receivers (subscribers). Rather, published messages are characterized into classes, without knowledge of subscribers. Subscribers express interest in one or more classes, and only receive messages that are of interest, without knowledge of publishers. Any standard media protocol may be used with the media flows including but not limited to HTTP or RSTP. In addition, any IP network 628 as well as the Web may be used with the media flows.

The source WTRU 655 establishes an original session 672 with the media server 660. The source WTRU pauses the media session 674. The source WTRU 655 publishes a new bookmark to the XMPP server 665 by sending a <pubsub> request message 676. The <pubsub> request message 676 includes a header that includes a from field which includes the source device identification (src JID), a to field which includes the XMPP server domain, a type, which may be a transaction id and a body, which may include a publish node including media session bookmarking storage path, an entry with elements fully describing the session including but is not limited to URL and time offset. The source WTRU 655 terminates the original media session 678. The XMPP server 665 broadcasts a new <pubsub> entry 680 to the target WTRU 670. The new <pubsub> entry may include a URL field, time offset field and a comment field. The target WTRU 670 establishes a session 682 with the media server 660 based on the received media stream bookmark information.

At any point in the method of FIG. 6B, additional actions may be performed between the XMPP server 665, the media server 660, the source WTRU 655 and the target WTRU 670. While XMPP is described in this embodiment any control protocol may be used.

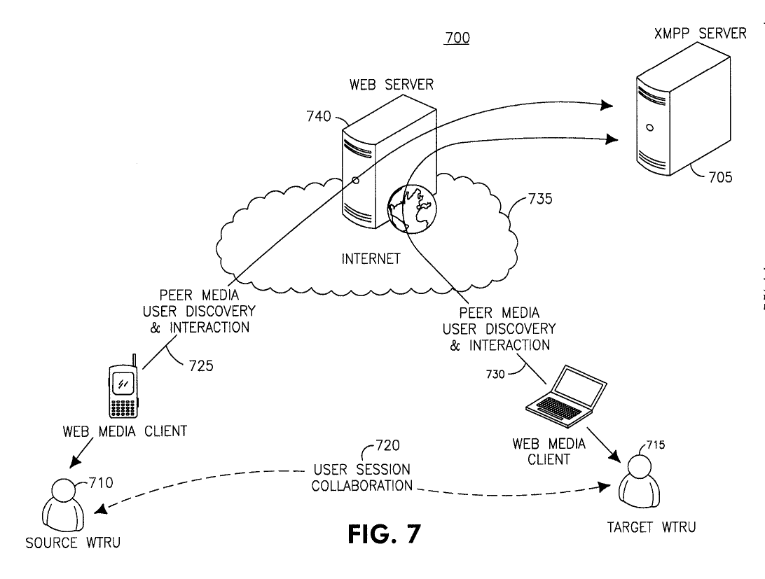

FIG. 7 shows a system diagram of an example of peer media user discovery and interaction 700 between a source WTRU 710 and a target WTRU 715 via an XMPP server 705 using a web server 740 as a proxy. Any standard media protocol may be used with the media flows including but not limited to HTTP or RSTP. In addition, any IP network 735 as well as the Web may be used with the media flows.

The source WTRU 710 may establish a collaborative session 720 with the target WTRU 715 using the XMPP server 705 via the web server 740. Both the source WTRU 710 and the target WTRU 715 may register 725, 730 with the XMPP server 705 and both the source WTRU 710 and the target WTRU 715 may publish or hide their availability. In addition, the source WTRU 710 and the target WTRU 715 may discover each other, invite each other or authorize/un-authorize each other 725, 730 for media session collaboration via the XMPP server 705.

At any point in the method of FIG. 7, additional actions may be performed between the XMPP server 705, the web server 740, the source WTRU 710 and the target WTRU 715. While XMPP is described in this embodiment any control protocol may be used.

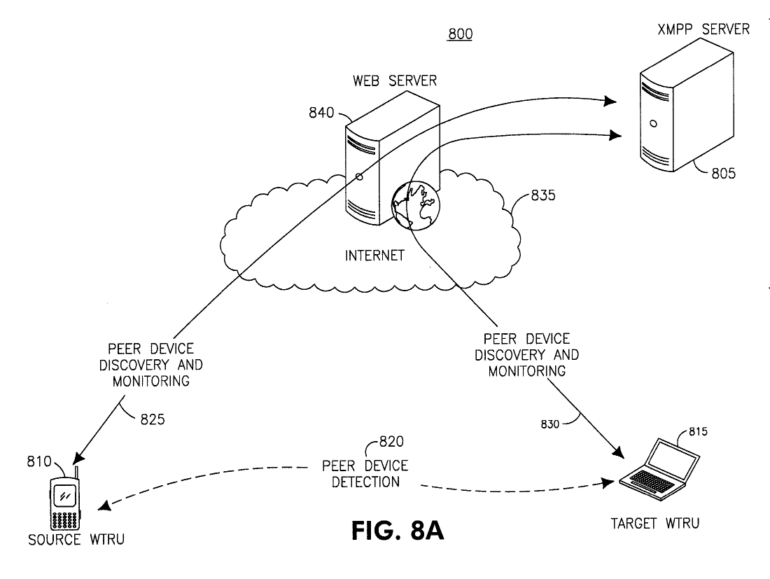

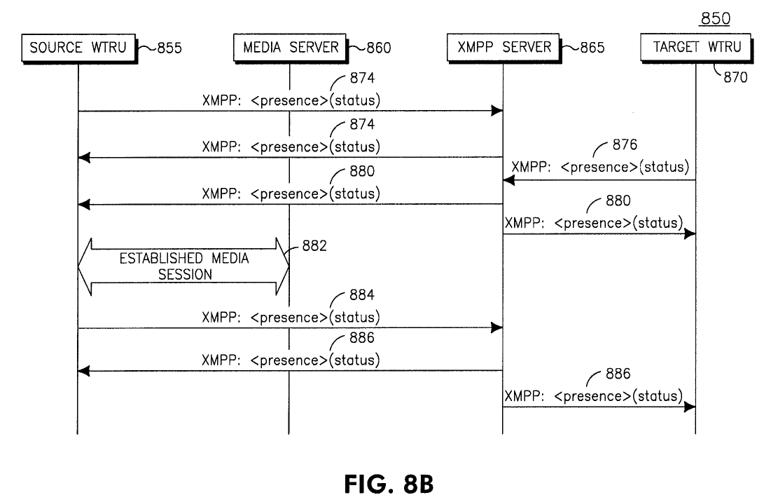

FIG. 8A shows a system diagram of an example of peer device detection and monitoring 800 between a source WTRU 810 and a target WTRU 815 via an XMPP server 805 using a web server 840 as a proxy. Any standard media protocol may be used with the media flows including but not limited to HTTP or RSTP. In addition, any IP network 835 as well as the Web may be used with the media flows.

The source WTRU 810 may establish a collaborative session 820 with the target WTRU 815 using the XMPP server 805 via the web server 840. Both the source WTRU 810 and the target WTRU 815 may signal their presence and their current status (e.g., idle, paused, playing) 825, 830 with regards to the media session to the XMPP server 805. Both the source WTRU 810 and the target WTRU 815 may signal additional status information 825, 830 with regards to the media session (e.g., current playing movie title) to the XMPP server 805, which may broadcast the information to all subscribed WTRUs.

At any point in the method of FIG. 8A, additional actions may be performed between the XMPP server 805, the web server 840, the source WTRU 825 and the target WTRU 815. While XMPP is described in this embodiment any control protocol may be used.

FIG. 8B shows a flow diagram of an example of peer client detection and monitoring 850 between a source WTRU 855 and a target WTRU 870 via an XMPP server 865 using an XML <presence> stanza.

The source WTRU 855 sends a <presence> status message 872 to the XMPP server 865. The status included in the <presence> message 872 may indicate that the media session state is idle. In addition, other information such as the device type and operating system may be sent by the source WTRU 855 to the XMPP server 865 in the <presence> message 872. The XMPP server 865 may broadcast the information in the <presence> message 874 to all currently subscribed WTRUs.

A target WTRU 870 may signal its presence 876 to the XMPP server 865 by sending a <presence> message 876. The XMPP server 865 may broadcast the presence information 880 to all currently connected WTRUs. The source WTRU 855 and the target WTRU 870 may detect each other's presence.

The source WTRU 855 may establish a new session 882 with the media server 860 and may send an updated <presence> message 884 to the XMPP server 865. The status in the <presence> message 884 may indicate that the source WTRU's 855 media sessions state is playing. The <presence> message 884 may also include other information such as device type, operating system or media metadata. The XMPP server 865 may broadcast the updated presence information 886 for the source WTRU 855 to all currently connected WTRUs. The target WTRU 870 may detect that the source WTRU 855 is playing and may initiate session retrieval based on the received information.

At any point in the method of FIG. 8B, additional actions may be performed between the XMPP server 870, the media server 860, the source WTRU 855 and the target WTRU 870. While XMPP is described in this embodiment any control protocol may be used.

In an alternative embodiment to FIG. 8B, peer client detection and monitoring 850 between a source WTRU 855 and a target WTRU 870 via an XMPP server 865 using an XML presence message and/or a personal eventing protocol (PEP). A PEP allows a user to publish information regarding itself. PEP is a protocol using the XMPP publish-subscribe <pubsub> protocol to broadcast state change events associated with instant messaging and presence.

The source WTRU 855 sends a <presence> message and a PEP protocol in order to reduce the data transported by the <presence> message to only the media session state of the WTRU. The PEP protocol is used to carry any additional status data such as device type or media session title.

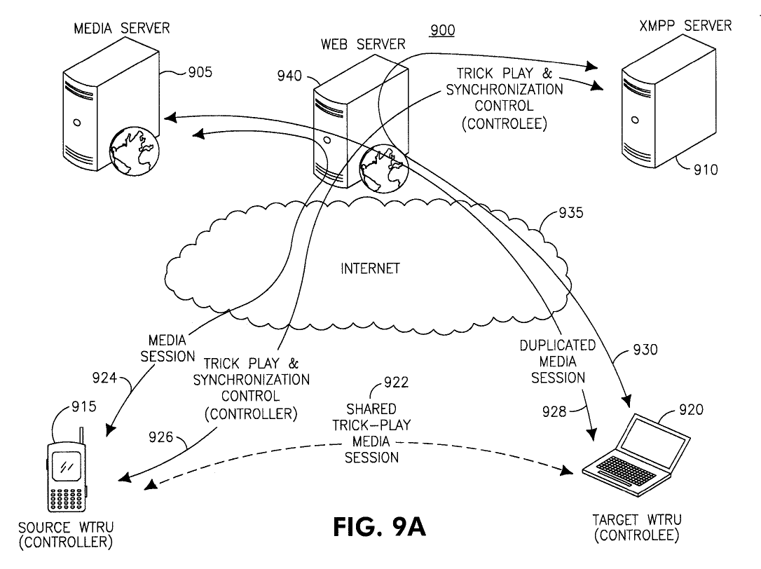

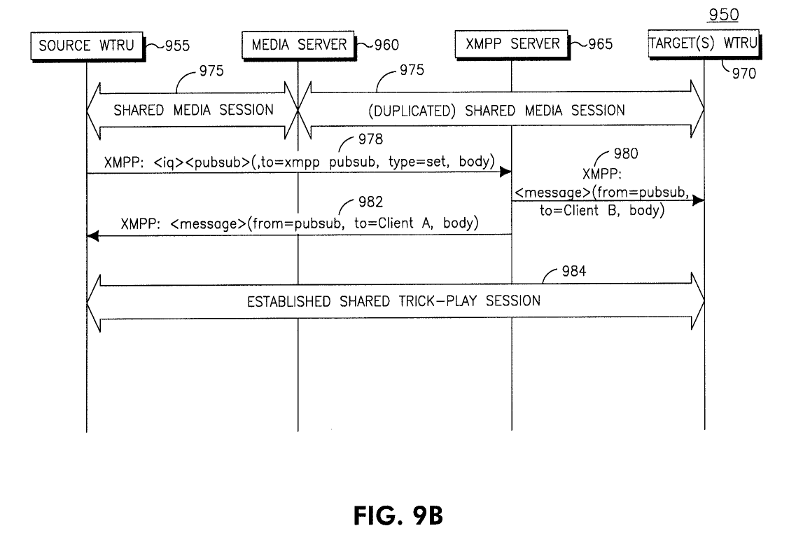

FIG. 9A shows system diagram of an example of shared trick-play session setup 900 between a source WTRU 915 and a target WTRU 920 via an XMPP server 910 using a web server 940 as a proxy. Any standard media protocol may be used with the media flows including but not limited to HTTP or RSTP. In addition, any IP network 935 as well as the Web may be used with the media flows.

The source WTRU 905 establishes an original media session 924 with the media server 905 via the web server 940 and a collaborative media session 922 with the target WTRU 920 by sending a session sharing request 926 via the XMPP server 910. The XMPP server 910 forwards the request 926 to the target WTRU 920. The target WTRU 920 establishes a session with the media server 928 based on the parameters received in the session sharing request 926. The target WTRU 920 sends a response 930 to the XMPP server 910 and the XMPP server 910 forwards the response 930 to the source WTRU 915. The source WTRU 915 and the target WTRU 920 share a media session 922. The source WTRU 915 is the controller and the target WTRU 920 is the controlee.

At any point in the method of FIG. 9A, additional actions may be performed between the XMPP server 910, the web server 940, the media server 905, the source WTRU 915 and the target WTRU 920. While XMPP is described in this embodiment any control protocol may be used.

FIG. 9B shows a flow diagram of an example of shared trick-play session setup 950 between a source WTRU 955 and a target WTRU 970 via an XMPP server 965.

A shared media session 975 is established between a source WTRU 955, a target WTRU 970 and a media server 960. The source WTRU 955 publishes a shared trick-play session invite request 978 to the XMPP server using an <iq> stanza and a <pubsub> protocol. Both the source WTRU 955 and the target WTRU 970 are subscribed to shared session events using the <pubsub> protocol through which the session invite 978 is published. The session invite request 978 specifies the following elements in the XML of the session invite request 978 a header including a to field; a type; and a body, which may include a publish node/shared trick-play session control path and a session invite request that may include a) a session id; b) a request type; c) the session members; and d) media state information, such as a media URL, timestamp or player state.

The XMPP server 965 may broadcast the new session invite as an XML <message> stanza 980 to all subscribed WTRUs. Each WTRU that receives the message from the XMPP server, regarding the invite, begins to actively monitor for subsequent messages related to the given session id in the session invite request. A shared trick-play session is established 984 between the source WTRU 955 and the target WTRU 970.

At any point in the method of FIG. 9B, additional actions may be performed between the XMPP server 965, the media server 960, the source WTRU 955 and the target WTRU 970. While XMPP is described in this embodiment any control protocol may be used.

In a first alternative embodiment to FIG. 9B, shared trick-play between a source WTRU 955 and multiple target WTRUs 970 via an XMPP server 965 occurs.

A shared media session is established between a source WTRU 955, multiple target WTRUs 970 and a media server 960. The source WTRU 955 publishes a shared trick-play session invite request to the XMPP server 965 using the <pubsub> protocol. Both the source WTRU 955 and the target WTRU 970 are subscribed to shared session events using the <pubsub> protocol through which the session invite 978 is published. The session invite request 978 specifies the following elements in the XML of the session invite request a header including a to field; a type; and a body, which may include a publish node/shared trick-play session control path and a session invite request that may include a) a session id; b) a request type; c) the session members; and d) media state information, such as a media URL, timestamp or player state. The source WTRU 955 specifies in the session members field of the session invite request each WTRU to which the trick-play session may be shared.

The XMPP server 950 may broadcast the new <pubsub> entry to all subscribed WTRUs. The broadcast of the <pubsub> entry ensures that the session invite request reached the target WTRUs 970. Each WTRU that receives the message from the XMPP server, regarding the <pubsub> entry, begins to actively monitor for subsequent messages related to the given session id in the session invite request.

A shared trick-play session may be established between the source WTRU 955 and the WTRUs specified in the session members field of the session invite request. The source WTRU 955 is the controller. The controller may be determined based upon which WTRU initiates the shared trick-play session, which WTRU the first listed in the session members field of the session invite request or by a specified controller field in the session invite request message.

In a second alternative embodiment to FIG. 9B shared trick-play between a source WTRU 955 and a target WTRU 970 via an XMPP server 965 using a multicast message occurs.

A shared media session is established between a source WTRU 955, a target WTRU 970 and a media server 960. The source WTRU 955 sends a shared trick-play session invite request using the XMPP server extended addressing. The session invite request specifies the following elements: 1) a header including an address field wherein the address field may be used to indicate a multicast service, an address type and a JID; and 2) a body, which may include a session invite request that may include the elements a) a session id; b) a request type; c) the session members with which the shared trick-play session may be shared; and d) media state information, such as a media URL, timestamp or player state. The source WTRU 955 specifies in the session members field of the session invite request each WTRU to which the trick-play session may be shared.

The XMPP server 965 may broadcast the session invite request to all WTRUs specified in the address field. Upon receipt of the session invite request, a target WTRU 970 may transmit a response with a unicast <message> to the source WTRU 955. The target WTRU 970 begins to actively monitor for subsequent messages related to the given session id in the session invite request.

A shared trick-play session may be established between the source WTRU 955 and the WTRU 970 that transmits a unicast <message>.

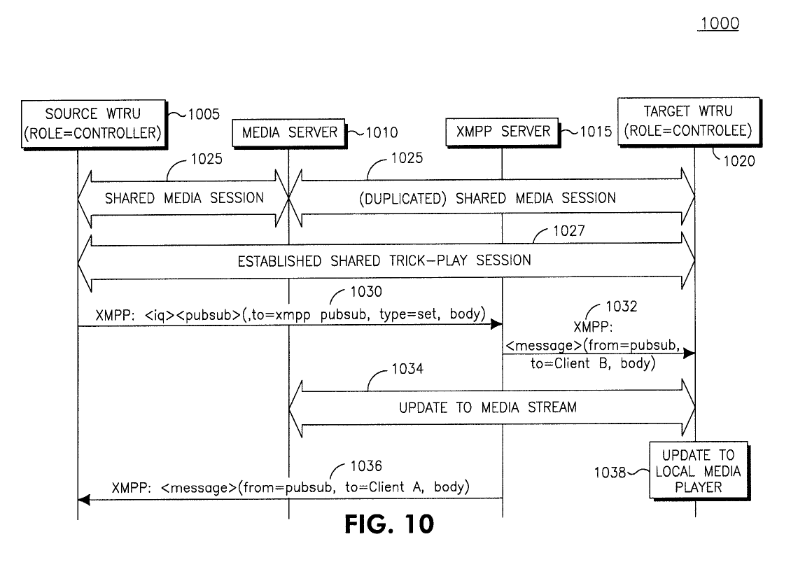

FIG. 10 shows a flow diagram of an example of trick-play command flow 1000 between a source WTRU 1005 and a target WTRU 1020 via an XMPP server 1015.

A shared media session 1025 is established between a source WTRU 1005, a target WTRU 1020 and a media server 1010. An shared trick-play session 1027 is established between a source WTRU 1005 and a target WTRU 1020. The source WTRU 1005 publishes a trick-play command request 1030 to the XMPP server 1015 using a <pubsub> protocol. Both the source WTRU 1005 and the target WTRU 1020 are subscribed to shared session events using the <pubsub> protocol through which the command request 1030 is published. The command request 1030 specifies the following elements in the XML: 1) a header including a to field and a type; and 2) a body, which may include a publish node/shared trick-play session control path and a trick-play command that may include a) a session id, which may be assigned at a setup time; b) a request type; c) session members; and d) media state information, such as a media URL, timestamp or player state.

The XMPP server 1015 may broadcast the new command request in <message> 1032 to all subscribed WTRUs. Each WTRU that receives the command request <message> 1032 from the XMPP server 1015 executes relevant media control procedures 1034 with the media server 1010 and updates its local media player state 1038. The source WTRU 1005 receives a trick-play command <message> 1036 from the media server as an acknowledgment of a successful transmission of the trick-play command request 1030.

At any point in the method of FIG. 10, additional actions may be performed between the XMPP server 1015, the media server 1010, the source WTRU 1005 and the target WTRU 1020. While XMPP is described in this embodiment any control protocol may be used.

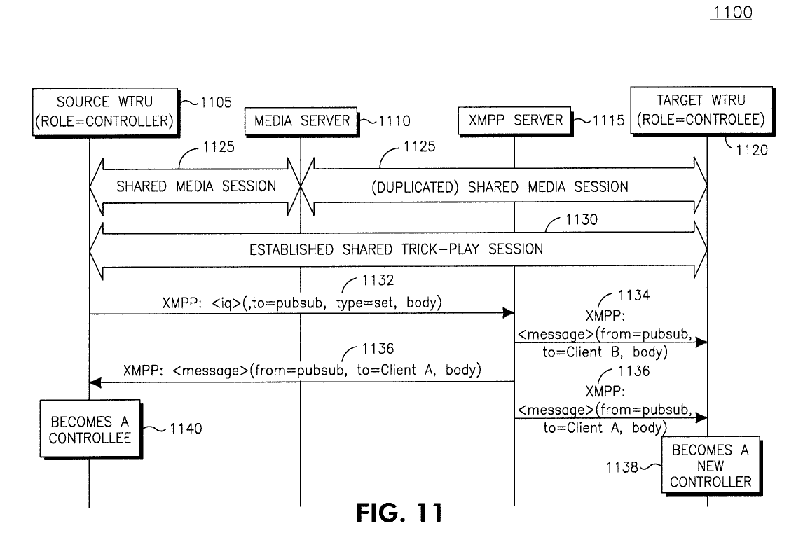

FIG. 11 shows a flow diagram of an example of trick-play control transfer using a push model 1100 between a source WTRU 1105 and a target WTRU 1120 via an XMPP server 1115.

A shared trick-play media session 1130 and a shared media session 1125 is established between a source WTRU 1105, a target WTRU 1120 and a media server 1110. The source WTRU 1105 is the controller and the target WTRU 1120 is the controlee in the established trick-play session 1130. The source WTRU 1105 issues a session update request 1132 specifying the target WTRU 1120 as the new controller to the XMPP server 1115. The session update request 1132 includes the following elements in the XML a header, including a to field, a type and a body.

The XMPP server 1115 may forward the session update request as a <message> 1134 to the target WTRU 1120 and the request <message> 1134 may include a from field, a to field and a body. The target WTRU 1120 may become the new controller 1138 and sends a response 1136 to the XMPP server 1115. The XMPP server 1115 forwards the response 1136 to the source WTRU 1105. The response 1136 may include a from field, a to field and a body. The source WTRU 1105 is now the controlee and the target WTRU 1120 is the controller.

At any point in the method of FIG. 11, additional actions may be performed between the XMPP server 1115, the media server 1110, the source WTRU 1105 and the target WTRU 1120. While XMPP is described in this embodiment any control protocol may be used.

In a first alternative embodiment to FIG. 11, trick-play control transfer using a push model between a source WTRU 1105 and a target WTRU 1120 via an XMPP server 1115 using a <pubsub> protocol occurs.

A shared trick-play media session and a shared trick-play session is established between a source WTRU 1105, a target WTRU 1120 and a media server 1110. The source WTRU 1105 is the controller and the target WTRU 1120 is the controlee in the established trick-play session. The source WTRU 1105 publishes a session update invite to the <pubsub> service. The session update invite includes the following elements in the <iq><pubsub> XML stanza: a header, including a to field, a type and a body. The body may include a publish node which includes the trick-play session control path and an entry for the session update invite request. The invite request may include the following elements: a session id, which may be assigned at setup time, a request type, which may indicate a session invite, wherein if a session id exists the request type is an update, session members, wherein the order of the session members indicates whether a member is a controller or a controlee and media state information, which may include a media URL, timestamp and a player state.

The XMPP server 1115 may broadcast the new <pubsub> entry to all subscribed WTRUs. The target WTRU 1120 may receive the session invite that includes an existing session id and may detect that the invite is an update. The order of the session members in the session member field may indicate that the target WTRU 1129 is the new controller on the condition that the target WTRU is listed first in the listing of session members. The source WTRU 1105 may receive the session invite that includes an existing session id. The receipt of the session invite with an existing session id indicates to the source WTRU 1105 successful transmission of the session invite. The source WTRU 1105 is now the controlee.

In a second alternative embodiment to FIG. 11, trick-play control transfer using a pull model between a source WTRU 1105 and a target WTRU 1120 via an XMPP server using a web server as a proxy occurs.

A shared trick-play media session is established between a source WTRU 1105, a target WTRU 1120 and a media server 1110. The source WTRU 1105 the controller and the target WTRU 1120 is the controlee in the established trick-play session. The target WTRU 1120 issues a request for trick-play control, which may be a unicast <message>, specifying the target WTRU 1170 as the new controller to the XMPP server 1115. The XMPP server 1115 may forward the request for trick-play control to the source WTRU 1105. The source WTRU 1105 may accept the request.

The source WTRU 1105 issues a session update request specifying the target WTRU 1120 as the new controller to the XMPP server 1115. The session update request includes the following elements in the XML, a header, including a to field, a type and a body.

The XMPP server 1115 may forward the session update request to the target WTRU 1105 and the request may include a from field, a to field and a body. The target WTRU 1120 becomes the new controller and sends a response to the XMPP server 1115. The XMPP server 1115 forwards the response to the source WTRU 1105. The response may include a from field, a to field and a body. The source WTRU 1105 is now the controlee and the target WTRU 1120 is the controller.

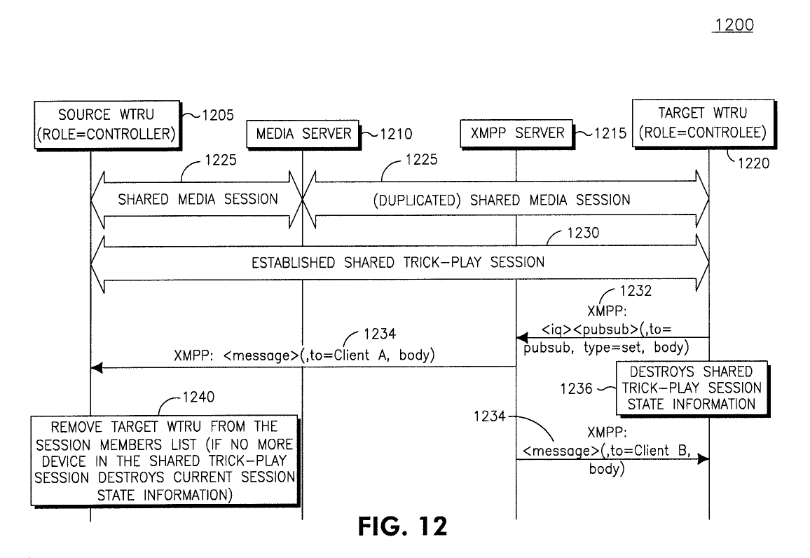

FIG. 12 shows a flow diagram of an example of a shared trick-play session leaving procedure 1200 between a source WTRU 1205, a target WTRU 1220 and an XMPP server 1215.

A shared trick-play media session 1230 and a shared media session 1225 is established between a source WTRU 1205, a target WTRU 1220 and a media server 1210. The source WTRU 1205 is the controller and the target WTRU 1220 is the controlee in the established trick-play session 1230. The target WTRU 1220 issues a shared trick-play leave request 1232 to the XMPP server 1215. The shared trick-play leave request 1232 may include the following elements in the XML a header, including a to field, which may include an XMPP <pubsub> service, a type and a body. The target WTRU 1220 destroys shared trick-play session state information 1236.

The XMPP server may forward the shared trick-play leave request <message> 1234 to the source WTRU 1205 and the target WTRU 1220. The source WTRU 1205 may remove the target WTRU from the list of controlled devices 1240 in the shared trick play session based on the session members list. On a condition that no other controlled devices are located in the session members list, the source WTRU 1205 destroys shared session trick-play state information 1240.

At any point in the method of FIG. 12, additional actions may be performed between the XMPP server 1215, the media server 1210, the source WTRU 1205 and the target WTRU 1220. While XMPP is described in this embodiment any control protocol may be used.

In an alternative embodiment to FIG. 12, a shared trick-play session leaving procedure between a source WTRU 1205, a target WTRU 1220 and an XMPP server 1215 <pubsub> service occurs.

A shared trick-play media session is established between a source WTRU 1205, a target WTRU 1220 and a media server 1210. The source WTRU 1205 is the controller and the target WTRU 1220 is the controlee in the established trick-play session. The target WTRU 1205 publishes a session leave request to the XMPP server 1215<pubsub> service. The session leave request may include the following elements in the <iq><pubsub> XML stanzas: a header, including a to field, a type and a body. The body may include a publish node, which includes the trick-play session control path and an entry for the session leave request. The session leave request may include the following elements: a session id, which may be assigned at setup time, a request type, which may indicate a session leave and session members, wherein the order of the session members indicates whether a member is a controller or a controlee.

The XMPP server 1215 may broadcast the new <pubsub> entry to all subscribed WTRUs. The target WTRU 1220 may destroy current trick-play session state information. In addition, the session with the media server may be torn down. The source WTRU 1205 may remove the target WTRU 1220 from the list of controlled devices in the shared trick play session based on the session members list. On a condition that no other controlled devices are located in the session members list, the source WTRU 1205 destroys shared session trick-play state information. In addition, the session with the media server 1210 may be terminated.

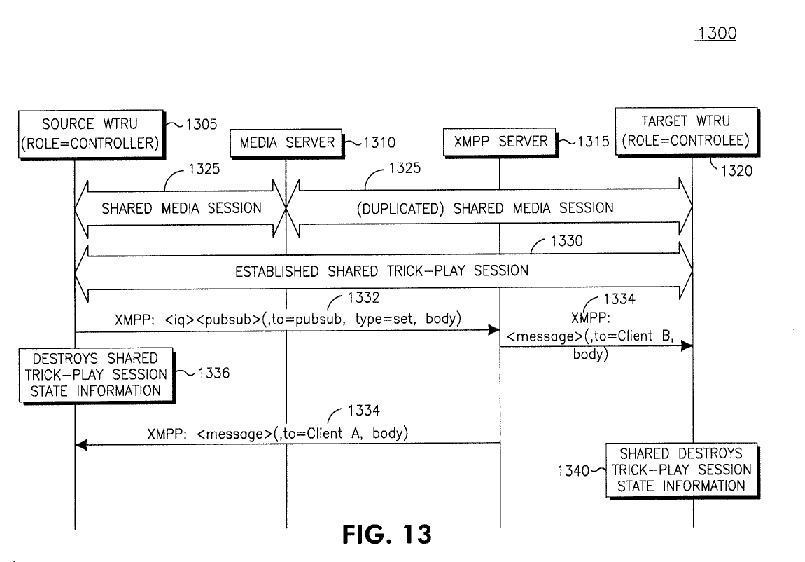

FIG. 13 shows a flow diagram of an example of a shared trick-play session termination procedure 1300 between a source WTRU 1305, a target WTRU 1320 and an XMPP server 1315.

A shared trick-play media session 1330 and a shared media session 1325 is established between a source WTRU 1305, a target WTRU 1320 and a media server 1310. The source WTRU 1305 is the controller and the target WTRU 1320 is the controlee in the established trick-play session 1330. The source WTRU 1305 issues a shared trick-play session termination request 1332 to the XMPP server 1315. The shared trick-play termination request 1332 may include the following elements in the XML <iq><pubsub> stanzas: a header, including a to field, a type and a body. The source WTRU 1305 destroys shared trick-play session state information 1336. In addition, the source WTRU 1305 may automatically destroy the session with the media server 1310.

The XMPP server 1315 may forward the shared trick-play session terminate request 1332 to the target WTRU 1320 and the source WTRU 1305 using a <message> 1334 which includes a to field and a body field. The target WTRU 1320 may destroy any shared-trick play session state information 1340. In addition, the target WTRU 1320 may automatically destroy the session with the media server.

At any point in the method of FIG. 13, additional actions may be performed between the XMPP server 1315, the media server 1310, the source WTRU 1305 and the target WTRU 1320. While XMPP is described in this embodiment any control protocol may be used.

In an alternative embodiment to FIG. 13, a shared trick-play session termination procedure between a source WTRU 1305, a target WTRU 1320 and an XMPP server 1315<pubsub> service occurs.

A shared trick-play media session is established between a source WTRU 1305, a target WTRU 1320 and a media server 1310. The source WTRU 1305 is the controller and the target WTRU 1320 is the controlee in the established trick-play session. The source WTRU 1305 publishes a session termination request to the XMPP server <pubsub> service. The session termination request may include the following elements in the <iq><pubsub> XML stanzas: a header, including a to field, a type and a body. The body may include a publish node, which includes the trick-play session control path and an entry for the session termination request. The session termination request may include the following elements: a session id, which may be assigned at setup time, a request type, which may indicate a session termination and session members, wherein the order of the session members indicates whether a member is a controller or a controlee.

The XMPP server 1315 may broadcast the new <pubsub> entry to all subscribed WTRUs. The source WTRU 1305 may destroy current trick-play session state information. In addition, the session with the media server may be torn down.

The target WTRU 1320 may receive the session termination request from the <pubsub> service and may destroy current trick-play session state information. In addition, the session with the media server may be torn down.

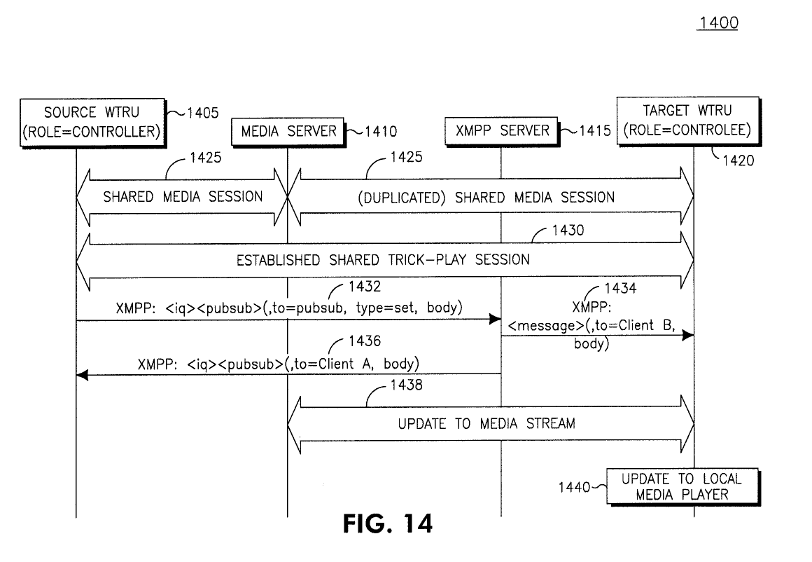

FIG. 14 shows a flow diagram of an example of group media stream synchronization 1400 between a source WTRU 1405, a target WTRU 1420 and an XMPP server 1415.

A shared trick-play media session 1430 and a shared media session 1425 is established between a source WTRU 1405, a target WTRU 1420 and a media server 1410. The source WTRU 1405 is the controller and the target WTRU 1420 is the controlee in the established trick-play session 1430. A controller may carry playback timing information that is used by controlees to adjust playback

The WTRU acting as a controller may also be the source of group synchronization between WTRUs. On a condition that a controlee provides synchronization commands and leaves the session, an automatic transfer of synchronization control would occur. The synchronization command is generated periodically. The period value may be fixed or variable during a session, is set so that it is not to short, which would avoid generating excessive synchronization signaling and not too long in order for media receiving devices to not drift apart between synchronization messages.

The source WTRU 1405 issues a synchronization command 1432 to the XMPP server 1415. The synchronization command 1432 may include timing information such as playback time, a synchronization threshold, a reference time stamp, which may be based on a common reference clock for network propagation delay estimation purposes. The synchronization command 1432 may also include the following elements in the XML <iq><pubsub> stanzas: a header, including a to field, a type and a body.

The XMPP server 1415 may forward the synchronization command as a <message> 1434 which may include a to field and a body to the target WTRU 1420 and the source WTRU 1405. The target WTRU 1420, based on its current media state and the synchronization information received, may determine if media synchronization is necessary. If media synchronization is necessary, the target WTRU 1420 may apply the relevant media control procedure to update the media stream 1428 and update the local media player 1440.

At any point in the method of FIG. 14, additional actions may be performed between the XMPP server 1415, the media server 1410, the source WTRU 1405 and the target WTRU 1420. While XMPP is described in this embodiment any control protocol may be used.

In an alternative embodiment to FIG. 14, a group media stream synchronization between a source WTRU 1405, a target WTRU 1420 an XMPP server 1415<pubsub> service occurs.

A shared trick-play media session is established between a source WTRU 1405, a target WTRU 1420 and a media server 1410. The source WTRU 1404 is the controller and the target WTRU 1420 is the controlee in the established trick-play session. The source WTRU 1405 publishes a session synchronization command to the XMPP server <pubsub> service. The synchronization command may include the following elements in the <iq><pubsub> XML stanzas: a header, including a to field, type and a body. The body may include a publish node, which includes the trick-play session control path and an entry for the synchronization command. The synchronization command may include the following elements: a session id, which may be assigned at setup time, a request type, which may indicate synchronization, session members, wherein the order of the session members indicates whether a member is a controller or a controlee, media state information, which may include a media URL, timestamp or player state and synchronization information which may include, threshold and a reference time stamp.

The XMPP server 1415 may broadcast the new <pubsub> entry to all subscribed WTRUs. The target WTRU 1420 may derive from the provided <pubsub> data the source WTRUs 1405 timestamps and may synchronize media with the source WTRU 1405. On a condition that the lag time exceeds a threshold, the target WTRU 1420 may proceed with adjusting its playback with the appropriate media stream and player control procedures.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A server for initiation of Inter-User Equipment Transfer (IUT) in a internet protocol (IP) based network, the server comprising:
a receiver configured to receive capability information in order to determine IUT capabilities of one or more wireless transmit/receive units (WTRUs) and to receive media session information to enable media session mobility and collaboration;
a processor configured to process the capability information and the media session information, synchronize media sessions and initiate IUT based on the capability information; and
a transmitter configured to transmit the media session information received from one or more source WTRUs to one or more target WTRUs.

2. The server of claim 1 wherein the processor is further configured to transform, modify and duplicate the media sessions.

3. The server of claim 1 wherein a control protocol is used for media session collaboration, control, detection and monitoring between the one or more source WTRUs and the one or more target WTRUs.

4. The server of claim 3 wherein the control protocol is an extensible messaging and presence protocol (XMPP).

5. The server of claim 1 wherein the media sessions are Hyper Text Transport Protocol (HTTP) or Real Time Streaming Protocol (RTSP) based media streams.

6. The server of claim 3 wherein the control protocol provides media session bookmarking wherein the one or more source WTRUs or the one or more target WTRUs may pause and/or resume the media sessions.

7. The server of claim 3 wherein the control protocol provides media session retrieval between the one or more source WTRUs and the one or more target WTRUs.

8. The server of claim 1 wherein the one or more source WTRUs or the one or more target WTRUs are a controller for the media session.

9. The server of claim 1 wherein the one or more source WTRUs or the one or more target WTRUs are a controlee for the media session.

10. The server of claim 1 wherein the one or more source WTRUs or the one or more target WTRUs terminate the media sessions.

11. A method for initiation of Inter-User Equipment Transfer (IUT) in an internet protocol (IP) based network, the method comprising:
receiving capability information in order to determine IUT capabilities of one or more wireless transmit/receive units (WTRUs) and receiving media session information to enable media session mobility and collaboration;
processing the capability information and the media session information, synchronize media sessions and initiate IUT based on the capability information; and
transmitting the media session information received from one or more source WTRUs to one or more target WTRUs.

12. The method of claim 11 further comprising:
transforming, modifying and duplicating media sessions.

13. The method of claim 11 further comprising:
using a control protocol for media session collaboration, control, detection and monitoring between the one or more source WTRUs and the one or more target WTRUs.

14. The method of claim 13 wherein the control protocol is an extensible messaging and presence protocol (XMPP).

15. The method of claim 11 wherein the media sessions are Hyper Text Transport Protocol (HTTP) or Real Time Streaming Protocol (RTSP) media streams.

16. The method of claim 13 wherein the control protocol provides media session bookmarking wherein the one or more source WTRUs or the one or more target WTRUs may pause and/or resume the media sessions.

17. The method of claim 13 wherein the control protocol provides media session retrieval between the one or more source WTRUs and the one or more target WTRUs.

18. The method of claim 11 wherein the one or more source WTRUs or the one or more target WTRUs are a controller for the media session.

19. The method of claim 11 wherein the one or more source WTRUs or the one or more target WTRUs are a controlee for the media session.

20. The method of claim 11 wherein the one or more source WTRUs or the one or more target WTRUs terminate the media sessions.
